(19) United States
(12) Patent Application Publication
(10) Pub. No.: US 2012/0054310 A1
(43) Pub. Date: Mar. 1, 2012

(54) TERMINAL, INTERMEDIATE NODE AND COMMUNICATION METHOD OF THE SAME

(76) Inventors: Jae Hoon KIM, Yongin-si (KR); Byoung-Joon LEE, Seongnam-si (KR); Myeong Wuk JANG, Seoul (KR); Ji Hoon LEE, Anyang-si (KR); Do Jun BYUN, Goyang-si (KR); Joong Hong PARK, Seoul (KR); Sung Chan CHOI, Euijeongbu-si (KR)

(21) Appl. No.: 13/027,364

(22) Filed: Feb. 15, 2011

(30) Foreign Application Priority Data
Aug. 30, 2010 (KR) 10-2010-0083912

(51) Int. Cl. G06F 15/16

(52) U.S. Cl. 709/218

(57) ABSTRACT

Provided is a communication method of a terminal, including generating, based on a characteristic of an application executed by at least one terminal in a virtual group, a content request message to request content stored by one or more other terminals in the virtual group, and transmitting the content request message to an intermediate node managing the at least one terminal to receive the content stored by the one or more other terminals.

### CROSS-REFERENCE TO RELATED APPLICATION(S)

This application claims the benefit under 35 U.S.C. §119(a) of Korean Patent Application No. 10-2010-0083912, filed on Aug. 30, 2010, in the Korean Intellectual Property Office, the entire disclosure of which is incorporated herein by reference for all purposes.

### BACKGROUND

1. Field

The following description relates to a terminal, an intermediate node, and a communication method of the same.

2. Description of Related Art

A plurality of communication members or terminals may form a virtual group, and the communication terminals may communicate with one another within this group. Such a group may also include intermediate nodes such as hubs, etc. When a terminal requests content from the virtual group, more than a necessary number of terminals may transmit the requested content, which may increase network traffic. When a content-sharing service is provided between members or terminals configuring a virtual group, it is desired that content may be shared more smoothly and conveniently.

### SUMMARY

In one general aspect, there is provided a communication method of a terminal, the method including generating, based on a characteristic of an application executed by at least one terminal in a virtual group, a content request message to request content stored by one or more other terminals in the virtual group, and transmitting the content request message to an intermediate node managing the at least one terminal to receive the content stored by the one or more other terminals.

The generating may include generating the content request message so that the content request message indicates that a plurality of responses received from a plurality of the one or more other terminals in the virtual group is required, in response to the application characteristic requiring the plurality of responses.

The generating may include generating the content request message so that the content request message indicates that a single response received from a single terminal in the virtual group is required, in response to the application characteristic requiring the single response.

The application may include a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.

In another general aspect, there is provided a communication method of an intermediate node, the method including receiving, from at least one terminal in a virtual group, a content request message including a characteristic of an application executed by the terminal, verifying the application characteristic from the content request message, and adaptively configuring a content forwarding table used to transmit, to the terminal, content requested by the terminal, based on the application characteristic.

The verifying may include verifying the application characteristic based on a name of the application extracted from the content request message.

The communication method may include transmitting the content request message to other terminals in the virtual group to request content corresponding to the content request message and to receive a latest version of the corresponding content, in response to the intermediate node storing the corresponding content, and generating an entry of the content forwarding table based on an interface via which the content request message is received from the terminal.

The communication method may further include transmitting the content request message to other terminals in the virtual group, wherein the adaptively configuring may further include generating an entry of the content forwarding table based on an interface via which the content request message is received from the terminal, in response to the content request message being transmitted to the other terminals in the virtual group.

The communication method may include retransmitting, to the terminal, corresponding content received from the other terminals in response to the transmission of the content request message, and maintaining the entry corresponding to the corresponding content in the content forwarding table for a predetermined period of time, in response to the application characteristic requiring a plurality of responses received from each of a plurality of terminals in the virtual group.

The communication method may include retransmitting, to the terminal, corresponding content received from the other terminals in response to the transmission of the content request message, and deleting the entry corresponding to the corresponding content from the content forwarding table, in response to the application characteristic requiring a response received from a single terminal in the virtual group.

The communication method may further include retransmitting the content to the terminal using the interface via which the content request message recorded in the content forwarding table is received, in response to the corresponding content being received from the other terminals in response to the transmission of the content request message.

The retransmitting may further include recording, as a reverse route, the interface via which the content request message is received.

The application may include a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.

A non-transitory computer-readable medium may store a program for instructing a computer to perform the method described above.

In still another general aspect, there is provided a terminal including a message generator to generate, based on a characteristic of an application executed by at least one terminal in a virtual group, a content request message to request content stored by one or more other terminals in the virtual group, and a transmitter to transmit the content request message to an intermediate node managing the at least one terminal to receive the content stored by the one or more other terminals.

The message generator generates the content request message so that the content request message indicates that a plurality of responses received from a plurality of the one or more terminals in the virtual group is required in response to the application characteristic requiring the plurality of responses, and the message generator generates the content request message so that the content request message indicates that a single response received from a single terminal in the virtual group is required in response to the application characteristic requiring the single response.

In a further general aspect, there is provided an intermediate node including a receiver to receive from at least one terminal in a virtual group, a content request message including a characteristic of an application executed by the at least one terminal, a characteristic verification unit to verify the application characteristic from the content request message, and a configuration unit to adaptively configure a content forwarding table used to transmit, to the terminal, content requested by the terminal, based on the application characteristic.

The intermediate node may further include a transmitter to transmit the content request message to other terminals in the virtual group to request content corresponding to the content request message and to receive a latest version of the corresponding content, in response to the intermediate node storing the corresponding content, wherein the configuration unit may generate an entry of the content forwarding table based on an interface via which the content request message is received from the terminal.

The transmitter may retransmit, to the terminal, the corresponding content received from the other terminals in response to the transmission of the content request message, the configuration unit may maintain the entry corresponding to the corresponding content in the content forwarding table for a predetermined period of time in response to the application characteristic requiring a plurality of responses received from each of a plurality of terminals in the virtual group, and the configuration unit may delete the entry corresponding to the corresponding content from the content forwarding table in response to the application characteristic requiring a response received from a single terminal in the virtual group.

The application may include a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.

According to an aspect, by adaptably configuring a content request message and a content forwarding table according to a characteristic of an application executed by a terminal, a transmission scheme may be efficiently selected, and a content transmission efficiency may also be enhanced.

According to an aspect, by receiving a single content request message from a terminal, and retransmitting the content request message to other terminals in a virtual group, a delay occurring when transmitting or receiving content or a packet having a particular object that requires a plurality of responses such as a search, a push, a member search, and the like may be minimized.

According to an aspect, when an intermediate node has content requested by a terminal, by retransmitting a content request message to other terminals in a virtual group at the same time as a content response, the intermediate node may receive the content of the latest version without a particular control message.

Other features and aspects will be apparent from the following detailed description, the drawings, and the claims.

### BRIEF DESCRIPTION OF THE DRAWINGS

FIG. 1 is a diagram illustrating an example of content-sharing in a case in which a terminal that requests content in a content centric network requires a response from one of other terminals.

FIG. 2 is a diagram illustrating an example of content-sharing in a case in which a terminal that requests content in a content centric network requires responses from each of other plurality of terminals.

FIG. 3 is a flowchart illustrating an example of a communication method of a terminal.

FIG. 4 is a flowchart illustrating an example of a communication method of an intermediate node.

FIG. 5 is a diagram illustrating an example of a content forwarding table configured in response to a characteristic of an application performed by a terminal in a content centric network requiring a response from another terminal.

FIG. 6 is a diagram illustrating an example of content-sharing in response to a characteristic of an application performed by a terminal in a content centric network requiring responses from each of a plurality of terminals.

FIG. 7 is a block diagram illustrating an example of a terminal.

FIG. 8 is a block diagram illustrating an example of an intermediate node.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Any progression of processing operations described is merely an example, however, and the sequence of operations is not limited to that set forth herein and may be changed as is known in the art, with the exception of operations necessarily occurring in a certain order. Also, description of well-known functions and constructions may be omitted for increased clarity and conciseness. Hereinafter, an intermediate node may correspond to one of other terminals connected to a terminal, and may correspond to a hub or a router that is generally used, or a device executing a similar function.

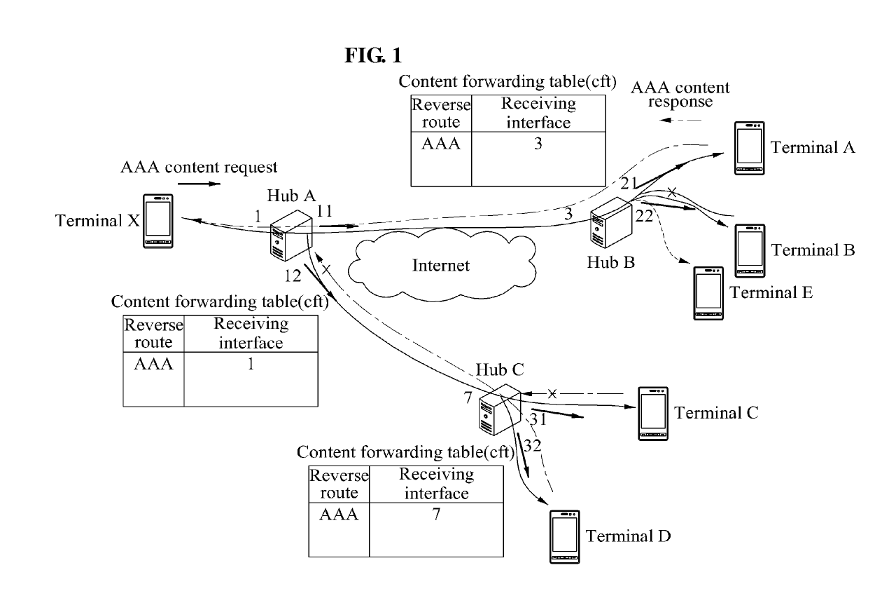

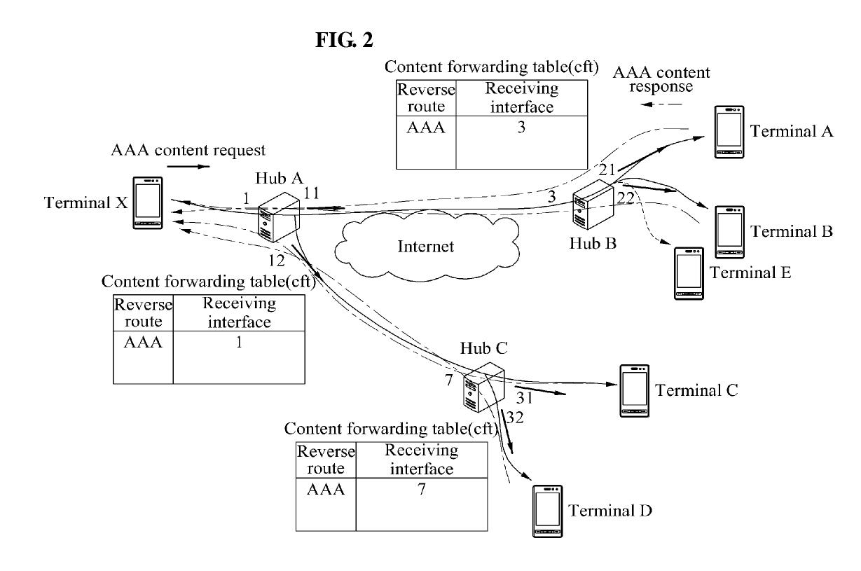

FIG. 1 is a diagram illustrating an example of content-sharing in a case in which a terminal that requests content in a content centric network may require a response from one of other terminals, and FIG. 2 is a diagram illustrating an example of content-sharing in a case in which a terminal that requests a content in a content centric network may require responses from each of other plurality of terminals.

Referring to FIG. 1 and FIG. 2, a content centric network may correspond to a network configured to more easily provide data or content to a terminal of a user requesting the content, and may have a transmission structure divided into interest and into data or content.

The terminal of the user requesting the content may generate an interest packet that may correspond to a control packet having a name of the requested content as a destination.

Network devices such as a terminal, an intermediate node, and the like in a virtual group that receives the interest packet may execute a search based on, for example, a content name, and an arbitrary device having the content corresponding to the content name in the interest packet may respond to the search.

In an example in which one of the other terminals in the virtual group that receives the interest packet via the intermediate node, for example, a hub, a router, and the like, has the corresponding content, the one of the other terminals having the corresponding content may transmit the content to the terminal that requests the content using a reverse route via which a content request message is received, that is, a reverse route that the interest packet passed through.

In this instance, unlike an Internet Protocol (IP), the content request message may not designate a predetermined node and thus, in an example in which a plurality of terminals or intermediate nodes in the virtual group have the corresponding content, network traffic may increase due to a plurality of content transmissions from the plurality of terminals or intermediate nodes having the corresponding content.

Thus, referring to FIG. 1, in an example in which the terminal that requests the content requires the response from the one of the other terminals, an intermediate device such as the intermediate node, the hub, the router, and the like, may reduce a network load by retransmitting the same number of contents as the number of content request messages received for the first time. The intermediate node may retransmit, to the terminal that requests the content, the corresponding content received as the response via the reverse route used to request the content request message.

In an example in which the terminal requesting the content requires the response from the one of the other terminals in the virtual group, that is, in an example in which the content is shared in a one to one transmission scheme, the content may be transmitted via a route determined by a transmission of the content request message. In such a case, the content may be transmitted to the terminal, and a number of instances of the contents being transmitted to the requesting terminal may be dependant on a number of the content request messages received by the intermediate node or other terminals.

In an example in which a single content request message is received by a terminal having the content, among each of the terminals A, B, C, D, E, and X, the terminal that requests the content may receive a single transmission of the content via the reverse route, that is, the route via which the content request message is received.

Referring to FIG. 1, when three users in the virtual group request contents, the requested number of contents may be transmitted to the terminals of the users that request the contents. In the present example, the number of transmission of contents may be three. Thus, a total of three transmissions of contents may be transmitted in the virtual group of FIG. 1.

Although a routing scheme for the content-sharing described in FIG. 1 may be efficient in a case of requiring a response from a single terminal, such as a data transmission, the routing scheme may be inefficient in an example requiring a plurality of responses or a packet transmission for a control use for various services as described in FIG. 2.

Referring to FIG. 2, in an example in which a terminal that requests content requires responses from each of a plurality of other terminals, that is, in a case of a structure in which the content is shared in a one to n transmission scheme, the terminal that requests the content may receive a number of transmissions of contents of which the number may be independent of a number of the content request messages received by an intermediate node, or other terminals.

In an example in which the terminal requires responses from each of all of the other terminals A, B, C, D, E, and X in a virtual group, each of all of the other terminals may receive the content request message, and the terminal may receive each response from all the terminals in the virtual group.

In this example, even though all of the other terminals receive a single content request message, the terminal that requests the content may receive a plurality of responses.

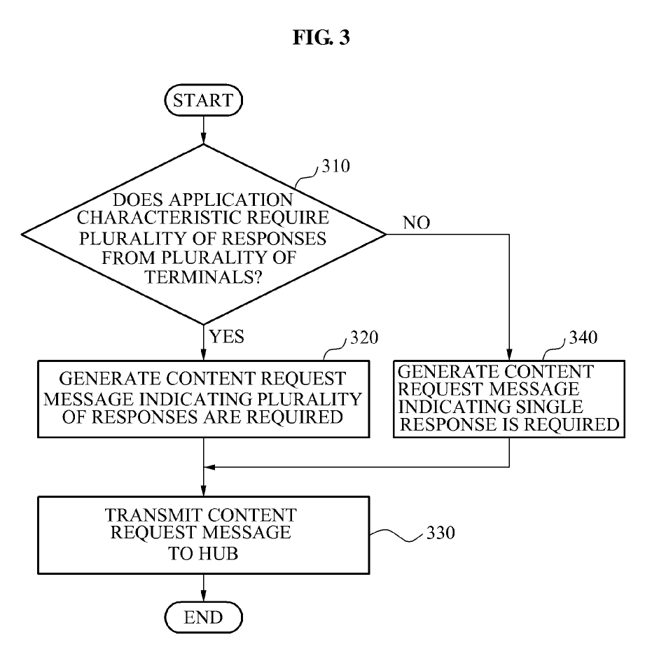

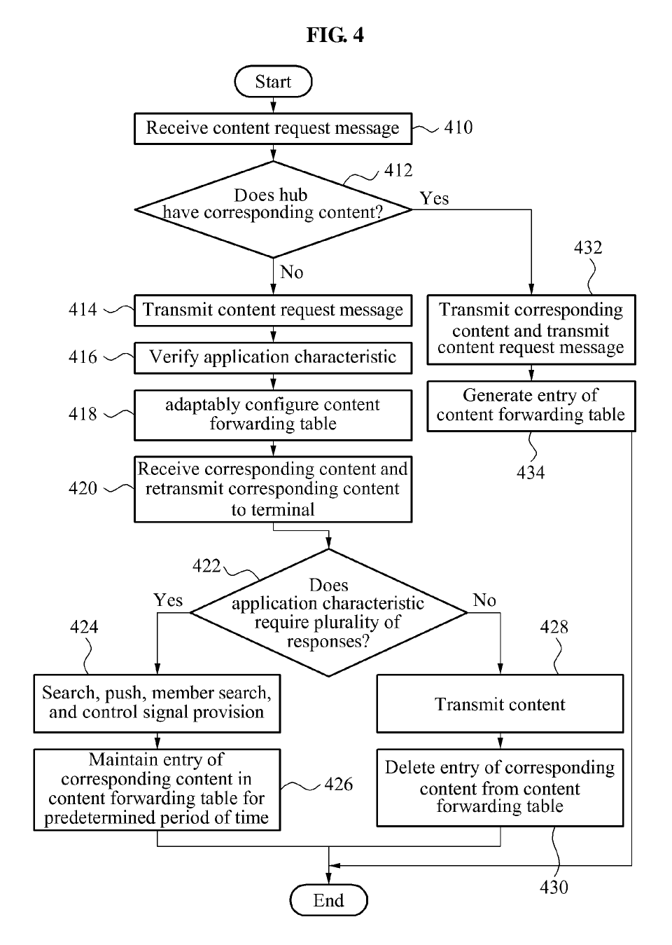

Hereinafter, a communication method of the terminal and the intermediate node, which may enhance a transmission efficiency of the content by adaptively transmitting the content based on an application characteristic of the terminal that requests the content will be described with reference to FIG. 3 and FIG. 4.

FIG. 3 is a flowchart illustrating an example of a communication method of a terminal.

Referring to FIG. 3, in operation 310, at least one terminal in a virtual group (hereinafter, referred to as a terminal) may determine whether an application characteristic requires a plurality of responses received from each of a plurality of terminals in the virtual group. It is understood that such responses may be required from a plurality of terminals in the virtual group without being required from all of the terminals in the virtual group. In this example, the response may correspond to the content requested by the terminal, or may correspond to a response to various queries of the terminal, such as a packet for a control use.

In operation 320, in a case in which the application characteristic is determined to require the plurality of responses received from each of the plurality of terminals in the virtual group in operation 310, the terminal may generate a content request message indicating that the plurality of responses are required.

In operation 340, in a case in which the application characteristic is determined to require a response received from a single terminal in the virtual group, such as a data transmission in operation 310, the terminal may generate the content request message indicating a single response, or a response from a single terminal, is required.

The application executed by the terminal may include a search application used for searching for the content stored by other terminals in the virtual group, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination of these.

In operation 330, the terminal may transmit the content request message to an intermediate node, for example, a hub, managing at least one terminal to receive the content stored by the other terminals.

FIG. 4 is a flowchart illustrating an example of a communication method of an intermediate node.

Referring to FIG. 4, in operation 410, the intermediate node may receive, from at least one terminal in a virtual group, a content request message including a characteristic of an application executed by the terminal.

In operation 412, the intermediate node may determine whether the intermediate node has corresponding content that corresponds to the content request message.

In operation 414, in a case in which the intermediate node does not have the corresponding content requested by the terminal in operation 412, the intermediate node may transmit the content request message to other terminals in the virtual group.

In operation 416, the intermediate node may verify the application characteristic from the content request message.

The application may include a search application used for searching for the content stored by other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination of these.

In operation 416, the intermediate node may verify the application characteristic, based on a name of the application extracted from the content request message.

For example, in a case in which the name of the application is ‘search’ or ‘push’, the intermediate node may determine, based on the name of the application, that the application performed by the terminal requires a plurality of responses received from each of a plurality of terminals in the virtual group.

Similarly, in a case in which the name of the application is ‘content request’, the intermediate node may determine that the application performed by the terminal requires a single response received from one of terminals in the virtual group.

A sequence of operation 414 and operation 416 may not be limited to the sequence described above, and may be optionally changed.

In operation 418, the intermediate node may adaptably configure a content forwarding table used for transmitting, to the terminal, the content requested by the terminal, based on the application characteristic.

As described above, in response to transmitting the content request message to the other terminals in the virtual group, the intermediate node may generate an entry of the content forwarding table, based on an interface via which the content request message is received from the terminal.

The intermediate node may retransmit, to the terminal, the content or response received from the other terminals, in the future, by recording, as the reverse route, the interface via which the content request message is received.

In operation 420, the intermediate node may retransmit, to the terminal, the corresponding content received from the other terminals in the virtual group, in response to the transmission of the content request message.

In response to the intermediate node retransmitting, to the terminal, the corresponding content received from the other terminals in the virtual group, the intermediate node may generate the entry corresponding to the corresponding content in the content forwarding table. The intermediate node may adaptably manage the content forwarding table according to the application characteristic.

In operation 422, the intermediate node may determine the application characteristic verified through the content request message in operation 414.

In response to the application characteristic requiring the plurality of responses received from each of a plurality of terminals in the virtual group in operation 424, the intermediate node may maintain the entry corresponding to the corresponding content in the content forwarding table for a predetermined period of time, for example, an expiration time, in operation 426.

The intermediate node may manage the content forwarding table so that the plurality of responses received from each of the plurality of terminals are transmitted to the terminal by reducing an amount of time remaining until the expiration time or by maintaining the entry of the content forwarding table during the expiration time, rather than deleting the entry immediately after transmitting the content to the terminal.

In a case in which the application characteristic require the plurality of responses received from the plurality of terminals in the virtual group, for example, a search, a push, a member search, a control signal provision applications, and the like may be given.

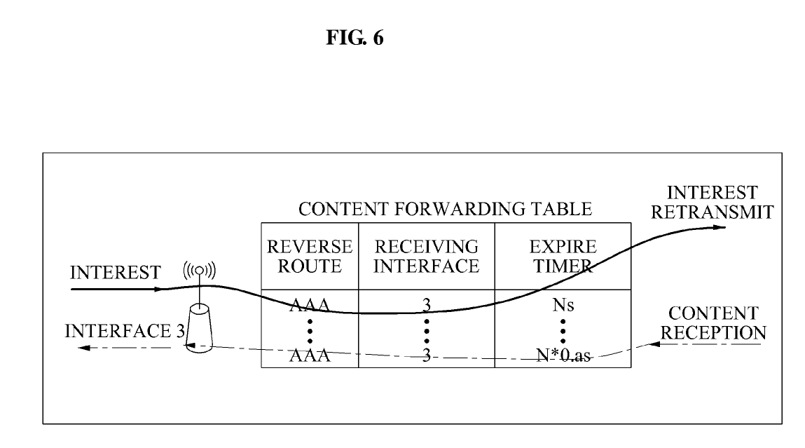

An example of the content forwarding table being configured in response to the application characteristic requiring the plurality of responses received from the plurality of terminals in the virtual group will be described with reference to FIG. 6.

In a case in which the application characteristic requires a response received from a single terminal in the virtual group, the intermediate node may retransmit the content to the terminal in operation 428, and may immediately delete the entry corresponding to the corresponding content from the content forwarding table in operation 430.

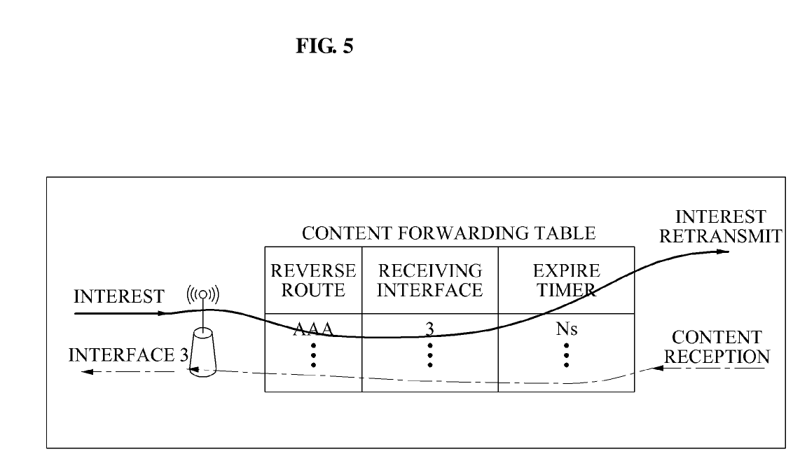

An example of the content forwarding table being configured in response to the application characteristic requiring a response received from a single terminal in the virtual group will be described with reference to FIG. 5.

In a case in which the intermediate node has the corresponding content required by the terminal in operation 412, the intermediate node may transmit the corresponding content to the terminal, and may transmit the content request message to other terminals in the virtual group to receive the content of the lasted version in operation 432.

For example, referring to FIG. 1, it may be assumed that a terminal X requests content AAA through a content request message, and an intermediate node Hub A has the content AAA. The intermediate node Hub A may provide the content AAA to the terminal X, without necessarily transmitting, to other terminals in the virtual group, the content request message transmitted by the terminal X.

In this case, the content request message requested by the terminal X may not be transmitted to the other terminals A, B, C, D, and E in the virtual group. However, as described above, in a case in which the intermediate node transmits the content request message to the other terminals in the virtual group, the intermediate node may generate the entry of the content forwarding table based on an interface via which the content request message is received from the terminal.

In an example in which the content request message is not transmitted to the other terminals in the virtual group, the intermediate node may not generate the entry of the content forwarding table.

In an example in which the entry of the content forwarding table may be generated only in response to the content request message being transmitted to the terminals A, B, C, D, and E, the intermediate node may not receive the content of the latest version from the terminals after the content has been changed.

Thus, referring to FIG. 1, in an example of content-sharing in which the terminal that requests the content requires a response from a single terminal, the intermediate node may transmit an additional content request message to receive the content of the latest version.

In operation 434, the intermediate node may generate the entry of the content forwarding table based on the interface via which the content request message is received from the terminal, after transmitting the content requested by the terminal.

The intermediate node may acquire the content of the latest version by simultaneously executing a content response and a retransmission of the content request message with respect to the other terminals in the virtual group.

The intermediate node according to an example may be configured by a terminal in the virtual group, and may be configured by a hub, a router, and other intermediate devices.

FIG. 5 is a diagram illustrating an example of a content forwarding table configured in response to a characteristic of an application performed by a terminal in a content centric network requiring a response from another terminal.

Referring to FIG. 5, after the intermediate node receives the content request message, an entry of the content forwarding table may be generated in response to an intermediate node retransmitting a content request message to other terminals in a virtual group to receive the content requested by the terminal.

The intermediate node may enable the content received in response to the response to be retransmitted to the terminal via the corresponding interface by generating the entry of the content forwarding table based on the interface via which the content request message is received from the terminal.

Referring to FIG. 5, in response to a characteristic of an application performed by a terminal requiring a response from another terminal, the terminal may receive the content requested from the other terminal in the virtual group. Thus, in response to the intermediate node receiving the content from the other terminal in the virtual group, the intermediate node may delete the entry corresponding to the corresponding content from the content forwarding table immediately after retransmitting the content to the terminal to prevent the content from continuing to be transmitted to the terminal.

FIG. 6 is a diagram illustrating an example of content-sharing in response to a characteristic of an application performed by a terminal in a content centric network requiring responses from each of a plurality of terminals.

Referring to FIG. 6, unlike the intermediate node of FIG. 5, the intermediate node may maintain the entry of the content forwarding table after receiving the content from the plurality of terminals and retransmitting the content to the terminal requesting the content, to receive a plurality of responses received from each of the plurality of terminals in the virtual group. Accordingly, the intermediate node may transmit a plurality of contents to the terminal for a period during which the entry is maintained in the content forwarding table.

The entry of the content forwarding table may be deleted from the content forwarding table by the intermediate node after a predetermined period of time, for example, a period of time designated as an expiration time, has passed.

According to an example, the terminal may generate the content request message according to the application characteristic, and the intermediate node may effectively acquire the content by adaptively configuring, based on the application characteristic, the content forwarding table having a form as described with reference to FIG. 5 or FIG. 6.

The processes, functions, methods and/or software described above including a communication method of a terminal and an intermediate node may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

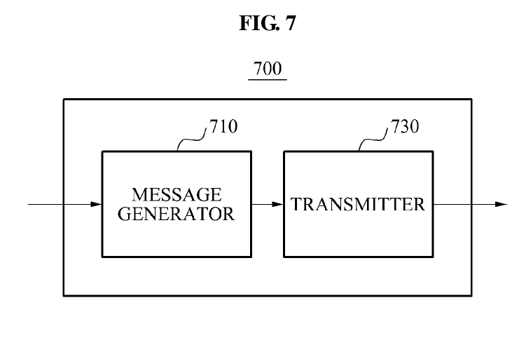

FIG. 7 is a block diagram illustrating an example of a terminal 700. Referring to FIG. 7, the terminal 700 may include a message generator 710 and a transmitter 730.

The message generator 710 may generate, based on a characteristic of an application executed by at least one terminal in a virtual group, a content request message for requesting content stored by other terminals in the virtual group.

In an example in which the application characteristic requires a plurality of responses received from each of a plurality of terminals in the virtual group, the message generator 710 may generate the content request message indicating that the content request message requires the plurality of responses.

In an example in which the application characteristic requires a response received from a single terminal in the virtual group, the message generator 710 may generate the content request message indicating that the content request message requires a single response.

The transmitter 730 may transmit the content request message to the intermediate node managing the at least one terminal to receive the content stored by the other terminals.

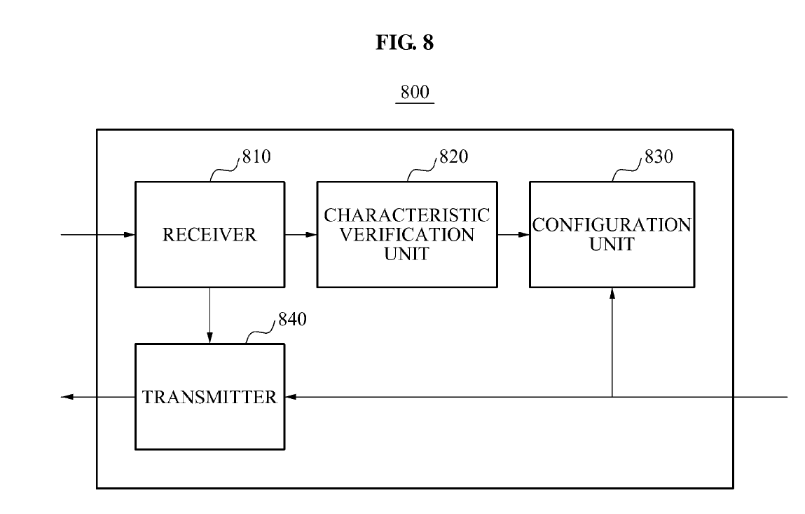

FIG. 8 is a block diagram illustrating an example of an intermediate node 800. Referring to FIG. 8, the intermediate node 800 may include a receiver 810, a characteristic verification unit 820, and a configuration unit 830.

The intermediate node 800 may further include a transmitter 840.

The receiver 810 may receive, from at least one terminal in a virtual group, a content request message including a characteristic of an application executed by the at least one terminal.

The characteristic verification unit 820 may verify the application characteristic from the content request message.

The configuration unit 830 may adaptively configure a content forwarding table used for transmitting, to the terminal, content requested by the terminal, based on the application characteristic.

In an example in which the intermediate node owns the corresponding content corresponding to the content request message, the transmitter 840 may transmit the content request message to other terminals in the virtual group to transmit corresponding content and to receive the content of the latest version at the same time.

In an example, the configuration unit 830 may generate an entry of the content forwarding table based on an interface via which the content request message is received from the terminal.

The transmitter 840 may retransmit, to the terminal, the corresponding content received from the other terminals in response to a transmission to the content request message.

In an example in which the application characteristic requires a plurality of responses received from each of a plurality of terminals in the virtual group, the configuration unit 830 may maintain the entry corresponding to the corresponding content in the content forwarding table for a predetermined period of time.

In an example in which the application characteristic requires a response received from a single terminal in the virtual group, the configuration unit 830 may delete the entry corresponding to the corresponding content from the content forward table.

The application may include a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination of these.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of a terminal, the method comprising:
generating, based on a characteristic of an application executed by at least one terminal in a virtual group, a content request message to request content stored by one or more other terminals in the virtual group; and
transmitting the content request message to an intermediate node managing the at least one terminal to receive the content stored by the one or more other terminals.

2. The communication method of claim 1, wherein the generating comprises generating the content request message so that the content request message indicates that a plurality of responses received from a plurality of the one or more other terminals in the virtual group is required, in response to the application characteristic requiring the plurality of responses.

3. The communication method of claim 1, wherein the generating comprises generating the content request message so that the content request message indicates that a single response received from a single terminal in the virtual group is required, in response to the application characteristic requiring the single response.

4. The communication method of claim 1, wherein the application includes a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.

5. A communication method of an intermediate node, the method comprising:
receiving, from at least one terminal in a virtual group, a content request message comprising a characteristic of an application executed by the terminal;
verifying the application characteristic from the content request message; and
adaptively configuring a content forwarding table used to transmit, to the terminal, content requested by the terminal, based on the application characteristic.

6. The communication method of claim 5, wherein the verifying comprises verifying the application characteristic based on a name of the application extracted from the content request message.

7. The communication method of claim 5, comprising:
transmitting the content request message to other terminals in the virtual group to request content corresponding to the content request message and to receive a latest version of the corresponding content, in response to the intermediate node storing the corresponding content; and
generating an entry of the content forwarding table based on an interface via which the content request message is received from the terminal.

8. The communication method of claim 5, further comprising:
transmitting the content request message to other terminals in the virtual group,
wherein the adaptively configuring further comprises generating an entry of the content forwarding table based on an interface via which the content request message is received from the terminal, in response to the content request message being transmitted to the other terminals in the virtual group.

9. The communication method of claim 8, comprising:
retransmitting, to the terminal, corresponding content received from the other terminals in response to the transmission of the content request message; and
maintaining the entry corresponding to the corresponding content in the content forwarding table for a predetermined period of time, in response to the application characteristic requiring a plurality of responses received from each of a plurality of terminals in the virtual group.

10. The communication method of claim 8, comprising:
retransmitting, to the terminal, corresponding content received from the other terminals in response to the transmission of the content request message; and
deleting the entry corresponding to the corresponding content from the content forwarding table, in response to the application characteristic requiring a response received from a single terminal in the virtual group.

11. The communication method of claim 8, further comprising:
retransmitting the content to the terminal using the interface via which the content request message recorded in the content forwarding table is received, in response to corresponding content being received from the other terminals in response to the transmission of the content request message.

12. The communication method of claim 11, wherein the retransmitting further comprises recording, as a reverse route, the interface via which the content request message is received.

13. The communication method of claim 8, wherein the application includes a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.

14. A non-transitory computer-readable medium storing a program for instructing a computer to perform the method of claim 1.

15. A terminal comprising:
a message generator to generate, based on a characteristic of an application executed by at least one terminal in a virtual group, a content request message to request content stored by one or more other terminals in the virtual group; and
a transmitter to transmit the content request message to an intermediate node managing the at least one terminal to receive the content stored by the one or more other terminals.

16. The terminal of claim 15, wherein the message generator generates the content request message so that the content request message indicates that a plurality of responses received from a plurality of the one or more terminals in the virtual group is required in response to the application characteristic requiring the plurality of responses, and
the message generator generates the content request message so that the content request message indicates that a single response received from a single terminal in the virtual group is required in response to the application characteristic requiring the single response.

17. An intermediate node comprising:
a receiver to receive, from at least one terminal in a virtual group, a content request message comprising a characteristic of an application executed by the at least one terminal;
a characteristic verification unit to verify the application characteristic from the content request message; and
a configuration unit to adaptively configure a content forwarding table used to transmit, to the terminal, content requested by the terminal, based on the application characteristic.

18. The intermediate node of claim 17, further comprising:
a transmitter to transmit the content request message to other terminals in the virtual group to request content corresponding to the content request message and to receive a latest version of the corresponding content, in response to the intermediate node storing the corresponding content;
wherein the configuration unit generates an entry of the content forwarding table based on an interface via which the content request message is received from the terminal.

19. The intermediate node of claim 18, wherein:
the transmitter retransmits, to the terminal, the corresponding content received from the other terminals in response to the transmission of the content request message;
the configuration unit maintains the entry corresponding to the corresponding content in the content forwarding table for a predetermined period of time in response to the application characteristic requiring a plurality of responses received from each of a plurality of terminals in the virtual group, and
the configuration unit deletes the entry corresponding to the corresponding content from the content forwarding table in response to the application characteristic requiring a response received from a single terminal in the virtual group.

20. The intermediate node of claim 18, wherein the application includes a search application used for searching for the content stored by the other terminals, a push application used for providing the same content to the other terminals, a member search application used for searching for a group member in the virtual group, an application for providing a control signal to the other terminals, an application for demanding a response from one of the other terminals and requesting the other terminals for a transmission of the content, or any combination thereof.
